(19) United States
(12) Patent Application Publication
(10) Pub. No.: US 2010/0103193 A1
(43) Pub. Date: Apr. 29, 2010

(54) IMAGE MONITOR APPARATUS AND COMPUTER-READABLE STORAGE MEDIUM STORING IMAGE MONITOR PROGRAM

(75) Inventors: Daisuke Abe, Fukuoka (JP); Eigo Segawa, Kawasaki (JP); Morito Shiohara, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/649,641

(22) Filed: Dec. 30, 2009

Related U.S. Application Data
(63) Continuation of application No. PCT/JP2007/064582, filed on Jul. 25, 2007.

(51) Int. Cl. G09G 5/00; G06F 17/00

(52) U.S. Cl. 345/620; 707/703; 345/634; 707/E17.02

(57) ABSTRACT

An image monitor apparatus includes a recognition process section that recognizes a process area in an original image which is inputted, a display image process section that generates and outputs an image for display by subjecting a process for display according to a user to the process area recognized by the recognition process section in the original image, a cut image record section that records an image of a partial area of the original image, the image cut from the original image, and further includes a record image process section that cuts the process area recognized by the recognition process section from the original image and causes the cut image record section to record an image in the process area of the original image, and generates and outputs an image for record by subjecting a process for record to the process area recognized by the recognition process section.

### CROSS-REFERENCE TO RELATED APPLICATION

This is a continuation application of PCT/JP2007/064582, filed on Jul. 25, 2007.

### FIELD

The embodiments discussed herein are related to an image monitor apparatus which processes an image obtained by a surveillance camera and the like to provide the image for monitor and a computer-readable storage medium storing a image monitor program which causes an information processing apparatus to operate as the image monitor apparatus.

### BACKGROUND

There has been commonly used a system to specify or monitor a person who comes in and goes out of a building such as a condominium, a person who is in a store such as a convenience store and the like, from an image of a camera arranged in advance. In addition, recent years, there has been introduced a system to automatically extract only a scene in which a person is photographed from among camera images which have been taken or recorded, for the purpose of labor saving for monitoring. A surveillance camera generally shoots not only a criminal such as a trespasser but also a resident of his or her condominium/apartment or a general customer, and so it is required to securely and strictly review, display and store an image of a surveillance camera also from the point of view of the personal information protect law.

In view of the circumstances described above, there has been proposed or practically used a technique to hide an object to be protected in an image by a pattern such as a mosaic as a technique to protect a privacy and the portrait right in the image.

In addition, Japanese Laid-open Patent Publication No. 2002-10063 describes that an area defined in advance such as a face of a person or a character in an image is extracted, and the extracted area is filled in with black or is attached with a pattern so that a specific area in the image is hidden. In addition, in Japanese Laid-open Patent Publication No. 2003-219383 and Japanese Laid-open Patent Publication No. H09-138827, an image in which nothing is hidden is distributed for a person who has an authority to see the image and an image in which a pattern such as a mosaic is pasted is distributed for a person who does not have an authority to see the image so that only the person who has the authority to see the image may see the image. However, when these conventional techniques are applied to an image monitor apparatus, there are following problems.

As Japanese Laid-open Patent Publication No. 2002-10063, by a technique to extract and fill in a face of a person or a character in an image, it is possible to protect a privacy and the portrait right but it is not possible to see an original image after the original image has been filled in. Thus, the technique is not suitable for monitoring an image in a case where accumulated images of the past are required to be checked on an as needed basis.

In addition, Japanese Laid-open Patent Publication No. 2003-219383 describes that an attention area such as a skin color area or a face area is detected and the attention area is subjected to a process not to be disclosed. As one method of this process not to disclose, encryption is described in this publication. When decryption is performed, a whole area including the attention area is disclosed, so that an encrypted image is stored and an encrypted and stored image of the past may be decrypted to be checked on an as needed basis. However, since an image is only encrypted, the encrypted image may be improperly decrypted. Therefore, security for images to be accumulated may not be sufficient.

Further, Japanese Laid-open Patent Publication No. H09-138827 also discloses a system of encryption and decryption. However, merely providing encryption may not be enough for security.

Incidentally, as a method to extract an attention area of an image, for example, there are known: as a method to detect a person, a method (a non-patent document, “Research on Subtraction System by Automatic Renewal of Background”, Tsujimura et al., Proceedings of IEICE 2003, p. 267, 2003) in which the method is realized by a common image processing called background difference method where a difference between a reference image called a background image where an object to be detected is not included and an input image where an object to be detected may be taken is calculated, and an area including the difference is detected as an object; as a method to detect a face, a method (a non-patent document, “Neural network-based face detection”, IEEE Transaction on Pattern Analysis and Machine Intelligence”, Vol. 20, No. 1, pp. 23-38, 1998) in which leaning face and non-face is performed in advance by a common learning method called neural network, and then a face area is detected from an inputted image based on the learning; and as a method to detect a character or a pattern, a method (a non-patent document, “Fast Deformable Template Matching for Character Recognition in Scene Images”, PRMU 2005-247, pp. 101-106, 2005) in which a character or a pattern to be recognized is stored as database and a character or a pattern in an image is compared to the database.

### SUMMARY

An image monitor apparatus to obtain the object described above, includes:

a recognition process section that recognizes a process area in an original image which is inputted;

a display image process section that generates and outputs an image for display by subjecting a process for display according to a user to the process area recognized by the recognition process section in the original image;

a cut image record section that records an image of a partial area of the original image, the image cut from the original image; and

a record image process section that cuts the process area recognized by the recognition process section from the original image and causes the cut image record section to record an image in the process area of the original image, and generates and outputs an image for record by subjecting a process for record to the process area recognized by the recognition process section.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an image monitor system including an image monitor apparatus according to a first embodiment of the invention;

FIG. 2 is a diagram illustrating a user information database in a user information management section;

FIG. 3 is a diagram illustrating process database in a process database and image restoration section;

FIG. 4 is a diagram illustrating a flow of data at the time of updating database in the image monitor apparatus illustrated in FIG. 1;

FIG. 5 is diagram illustrating a flow of data at the time of displaying an image of the image monitor apparatus illustrated in FIG. 1.

FIG. 6 is a diagram explaining a recognition process of a process area in a recognition process section;

FIG. 7 is a diagram explaining a process in a display image process section;

FIG. 8 is diagram illustrating a flow of data at the time of recording an image of the image monitor apparatus illustrated in FIG. 1;

FIG. 9 is diagram explaining a process for record by a record image process section;

FIG. 10 is a diagram illustrating a data structure of an image;

FIG. 11 is a diagram illustrating a flow of data at the time of reproducing an image of the image monitor apparatus illustrated in FIG. 1;

FIG. 12 is a diagram explaining an original image restoration process of the process database and image restoration section at the time of reproduction of an image;

FIG. 13 is a diagram illustrating an image monitor system including an image monitor apparatus of a second embodiment according to the invention; and

FIG. 14 is a diagram illustrating input identification information managed in an input identification information management section.

### DESCRIPTION OF EMBODIMENTS

In the following, exemplary embodiments according to the invention will be explained.

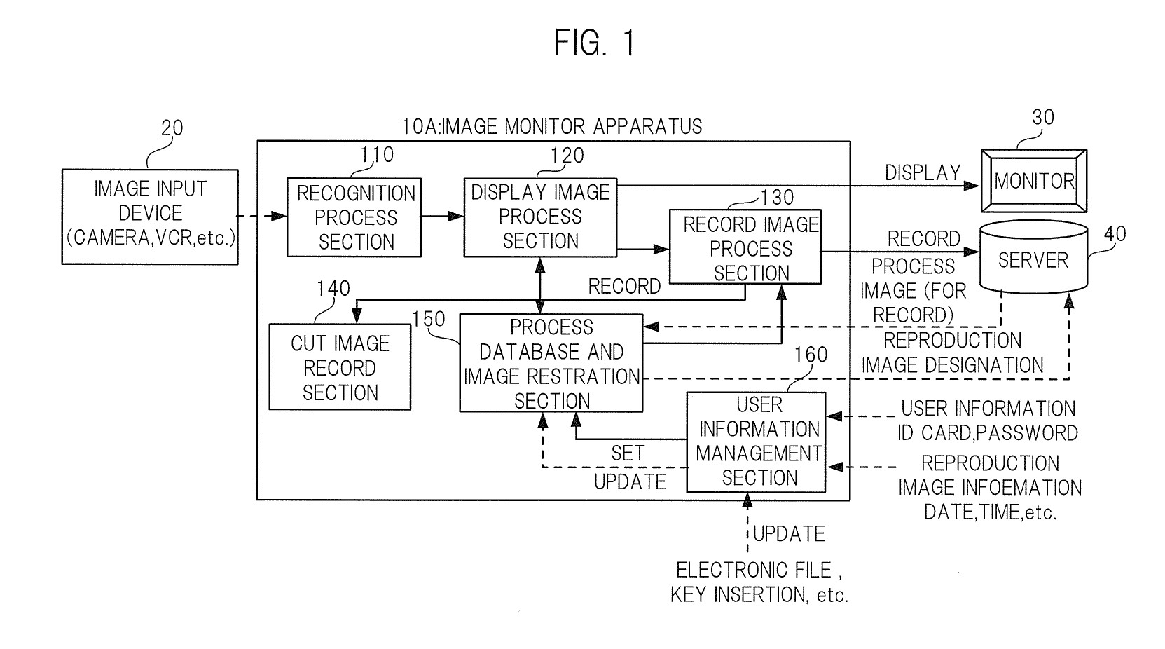

FIG. 1 is a diagram illustrating an image monitor system including an image monitor apparatus according to a first embodiment of the invention.

The image monitor system illustrated in FIG. 1 includes: an image monitor apparatus 10A; an image input device 20 to input an image to the image monitor apparatus 10A; a monitor 30 which receives and displays an image from the image monitor apparatus 10A; and a server 40 which is connected via a communication line such as the Internet to the image monitor apparatus 10A, receives an image from the image monitor apparatus 10A and records the image. An image recorded in the server 40 is downloaded again to the image monitor apparatus 10A according to an instruction from the image monitor apparatus 10A.

The image monitor device 10A includes: a recognition process section 110; a display image process section 120; a record image process section 130; a cut image record section 140; a process database and image restoration section 150; and a user information management section 160.

As details of each section will be described later, a summary of each section is as follows.

The recognition process section 110 recognizes an area to be processed in an original image inputted.

The display image process section 120 generates and outputs an image for display by applying a process for display to the area to be processed recognized by the recognition process section 110 according to a user (for example, a monitoring person).

The record image process section 130 generates and outputs an image for record by cutting the area to be processed recognized by the recognition process section 110 from the original image, causing the cut image record section 140 to record an image of the area to be processed in the original image and applying a process for record to the area to be processed recognized by the recognition process section 110.

Further, the cut image record section 140 records the image of the area to be processed of the original image, which is cut out of the original image and is sent out from the record image process section 130.

The process database and image restoration section 150 plays both a role of preparing information to be used for a process of the area to be processed recognized by the recognition process section 110 such as a pattern to be pasted in the area to be processed and sending the information to the display image process section 120 and the record image process section 130 and a role of restoring the original image based on the images inputted from the server 40 and the cut image record section 140.

In addition, the user information management section 160 serves to manage information to identify a user (for example, a monitoring person) who uses the image monitor system and an authority to use of the user and the like.

A user who is going to use the image monitor system inputs user information into the image monitor apparatus 10A, for example, by inserting an ID card the user owns or inputting a password. For the password, inputting a data string in which alphabets and numerics are combined, biometric authentication using a fingerprint, a vein pattern and the like are utilized. The user information is inputted to the user information management section 160. In the user information management section 160, it is determined, based on the user information, whether or not the user is a user who has an authority to use the image monitor system, or what a scope of the authority is. When the user is determined to have an authority to use, information representing the authority is inputted to the process database and image restoration section 150. The process database and image restoration section 150 informs the display image process section 120 and the record image process section 130 of a process method according to the authority to use.

After the preparation stage described above, an image is inputted from the image input device 20. This inputted image (here, this image is referred to as an original image) is inputted to the recognition process section 110, a process area composed of, for example, a human face or a whole person is recognized and position information of the process area is inputted along with the original image to the display image process section 120. In the display image process section 120, the process area recognized by the recognition process section 110 is processed based on the process method informed from the process database and image restoration section 150, and an image after such processing (a process image (for display)) is sent to the monitor 30 to be displayed on the monitor 30.

In addition, the original image and the position information of the process area recognized in the recognition process section 110 are inputted via the display image process section 120 to the record image process section 130. In the record image process section 130, the process area recognized in the recognition process section 110 of the original image is processed for record. The processed image (a process image (for record)) is sent to the server 40 to be recorded in the server 40.

In addition, in the record image process section 130, a process of cutting an image of the process area recognized in the recognition process section 110 is also performed and this cut out image (cut image) is recorded in the cut image record section 140.

When an image in the past is reproduced, a process image (for record) is downloaded from the server 40 and a cut image is read out from the cut image record section 140. Both of the process image (for record) and the cut image are inputted to the process database and image restoration section 150 to restore an original image in the past. The restored original image is inputted to the display image process section 120. In the display image process section 120, the restored original image is subjected to a process according to an authority to use of a user who observes the currently restored image (including no process depending on the authority to use) so that a process image (for display) is generated. The generated process image (for display) is sent to the monitor 30 to be displayed on the monitor 30.

In the following, details of each section of the image monitor apparatus 10A illustrated in FIG. 1 will be explained.

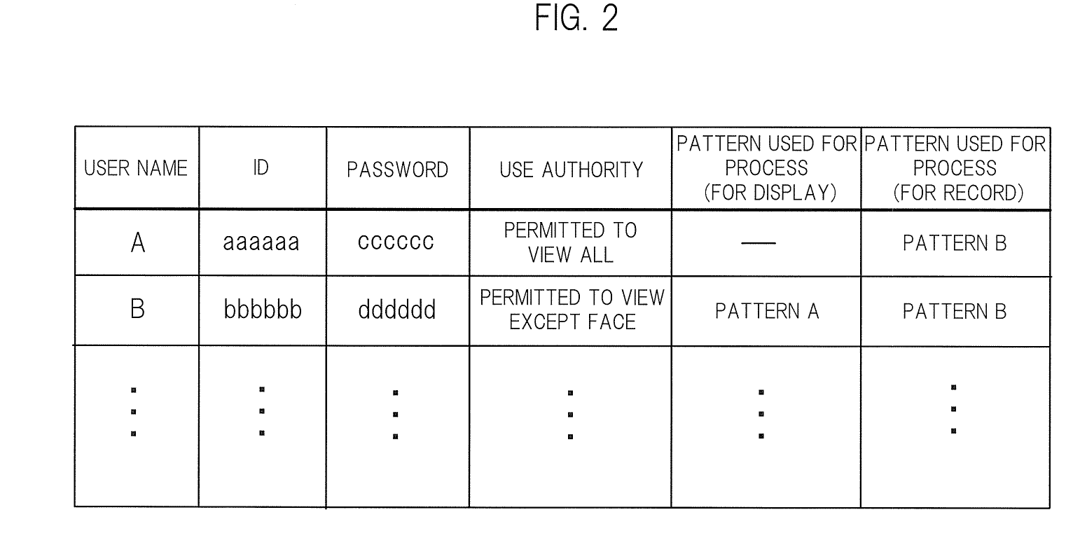

FIG. 2 is a diagram illustrating a user information database in the user information management section 160.

Here are registered, “USER NAME”, “ID” of a user, “PASSWARD”, “USE AUTHORITY”, “PATTERN USED FOR PROCESS (FOR DISPLAY)”, and “PATTERN USED FOR PROCESS (FOR RECORD)” of the user.

For example, for a person A, “AUTHORITY TO USE” is “PERMITTED TO VIEW ALL”, and therefore the cell of “PATTERN USED FOR PROCESS (FOR RECORD)” is empty. However, even if a current user is the person A having the authority of “PERMITTED TO VIEW ALL”, since a user who restores an image after record is not always the person A, “PATTERN USED FOR PROCESS (FOR RECORD)” is defined, and the image for record is subjected to a process.

On the other hand, for a person B, “USE AUTHORITY” is “PERMITTED TO VIEW EXCEPT FACE”, and for display, “PATTERN USED FOR PROCESS (FOR DISPLAY)” is defined, and an image for display is also subjected to a process.

In addition, the user information management section 160 records and manages information about a user in current use and history information such as usage time and the like of a user in the past. In the user information management section 160 is in advance recorded an administrator who updates user information and the like in the user information management section 160.

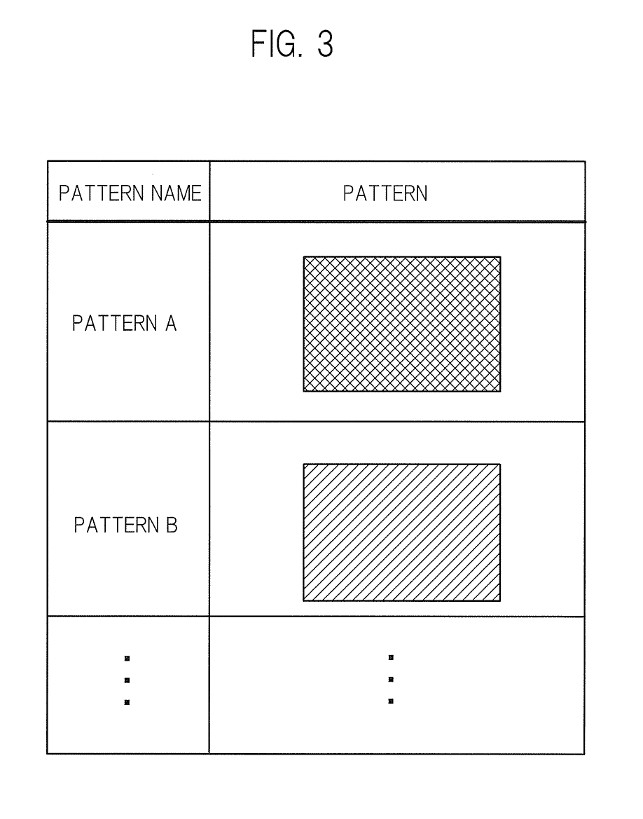

FIG. 3 is a diagram illustrating process database in the process database and image restoration section 150. In here, various patterns to be used for processing an image are defined.

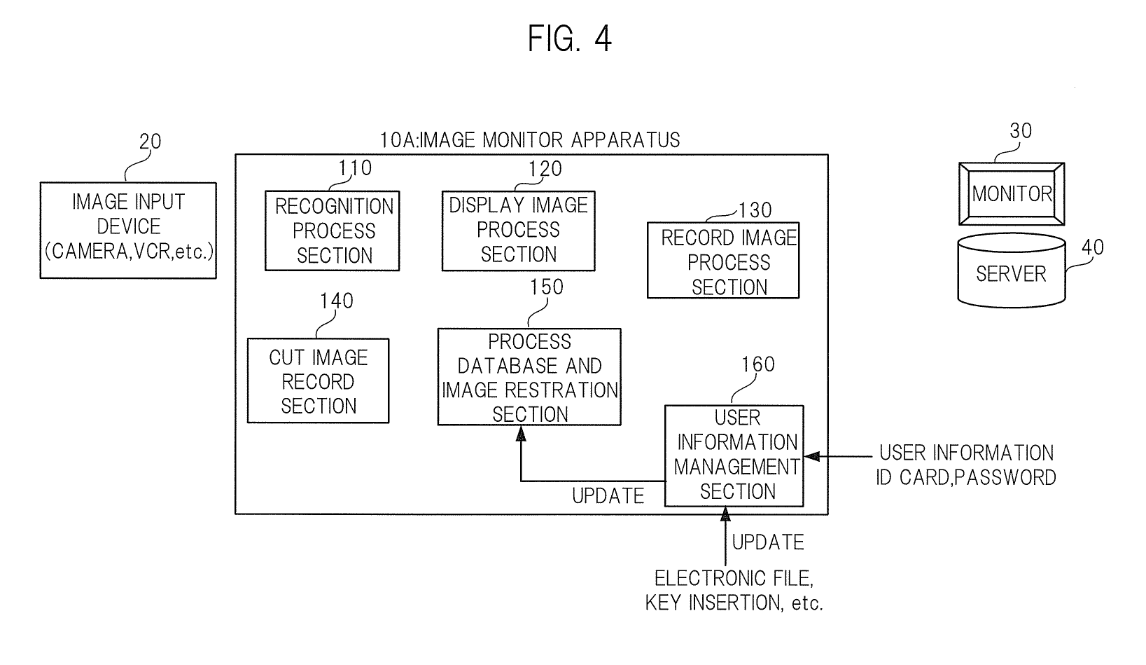

FIG. 4 is a diagram illustrating a flow of data at the time of updating database in the image monitor apparatus 10A in illustrated in FIG. 1

Through insertion of an ID card or input of an password and the like, the user information management section 160 is caused to recognize an administrator having a proper authority, and through input of an electronic file or key-in and the like, updating the user information database (see FIG. 2) stored in the user information management section 160 and updating process database (see FIG. 3) stored in the process database and image restoration section 150 via the user information management section 160 are performed. In the user information management section 160 is recorded information about day and time of the update and the administrator as history.

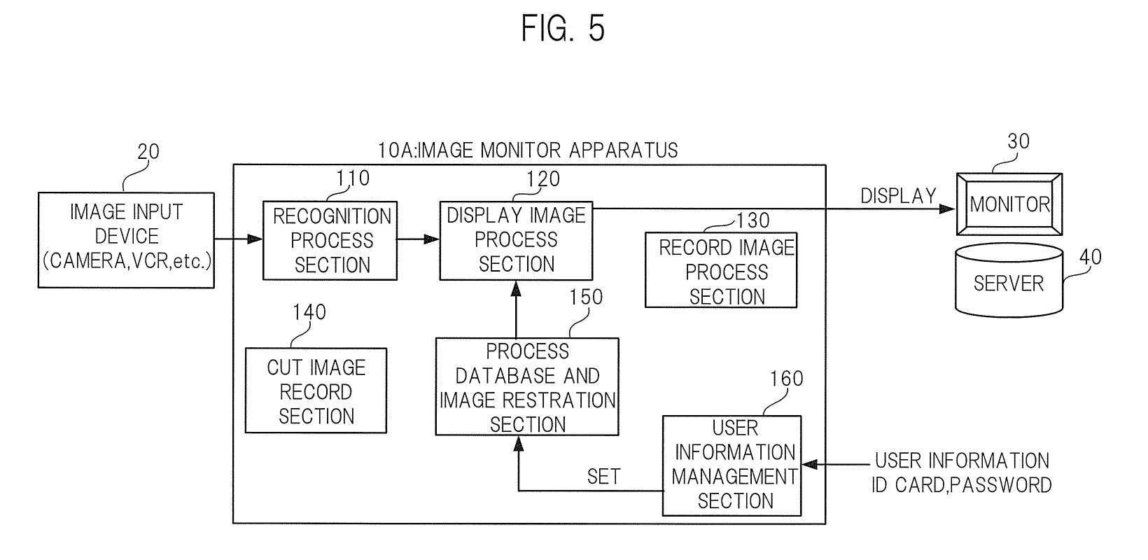

FIG. 5 is a diagram illustrating a flow of data at the time of displaying an image of the image monitor apparatus 10A illustrated in FIG. 1.

Here, the user information management section 160 is caused to recognize a user to be a user who has a proper authority to monitor an image through insertion of an ID card, input of a password or the like. Then, the user information management section 160 informs the process database and image restoration section 150 of information about the authority to use according to the current user and information about a pattern to be used for a process. The process database and image restoration section 150 informs the display image process section 120 of the pattern for a display process based on the information. The display image process section 120 processes the image for display using the pattern informed.

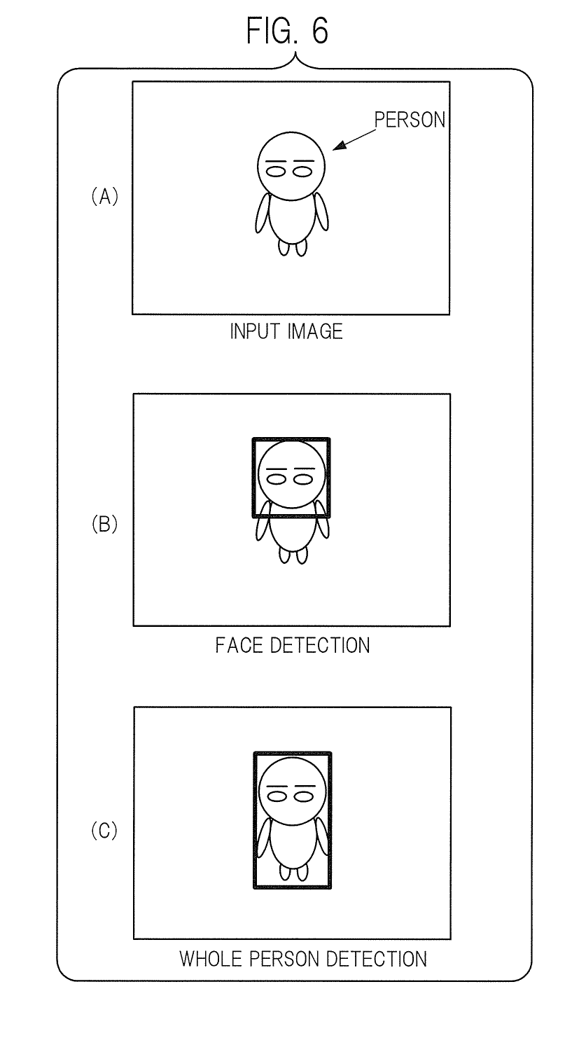

FIG. 6 is a diagram explaining a recognition process of a process area in the recognition process section 110. FIG. 6 illustrates one frame image of an image (moving picture). In the recognition process section 110, a face recognition process and a person recognition process are performed using an original image (A) inputted from the image input device 20, and a process area (B) surrounding the face and a process area (C) surrounding the person are recognized.

In here as illustrated, an example in which the person “B” illustrated in FIG. 2 is a user will be explained. In other words, an example in which, for display, a process image (for display) where a face is processed in mosaic with a pattern A is generated will be explained. Here, in addition, as an image for record, an image where a person is wholly processed in mosaic independently of a user is generated and recorded in the server 40 (see FIG. 1).

Accordingly, in the recognition process section 110, as illustrated in FIG. 6, face detection and whole person detection are performed.

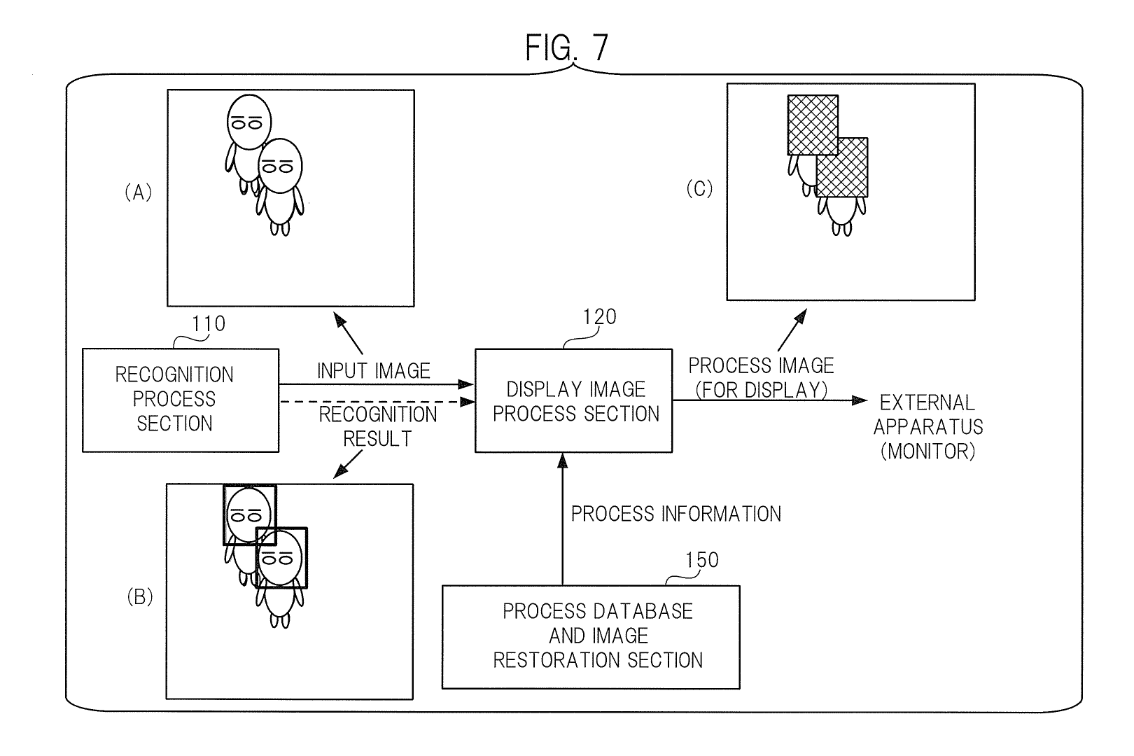

FIG. 7 is a diagram explaining a process in the display image process section 120.

As described above, in the recognition process section 110, the process area (B) surrounding a face is recognized as an area for display from the original image (A), and the original image and position information of the recognized process area are inputted to the display image process section 120. In addition, process information representing a pattern for process is also inputted from the process database and image restoration section 150 to the display image process section 120. In the display image process section 120, a process image (for display) (C) where the process area (B) in the original image (A) is covered with a pattern is generated based on those pieces of information. The process image (for display) (C) is sent to the external monitor 30 illustrated in FIG. 5, and the monitor 30 displays the process image (for display) as a visible image.

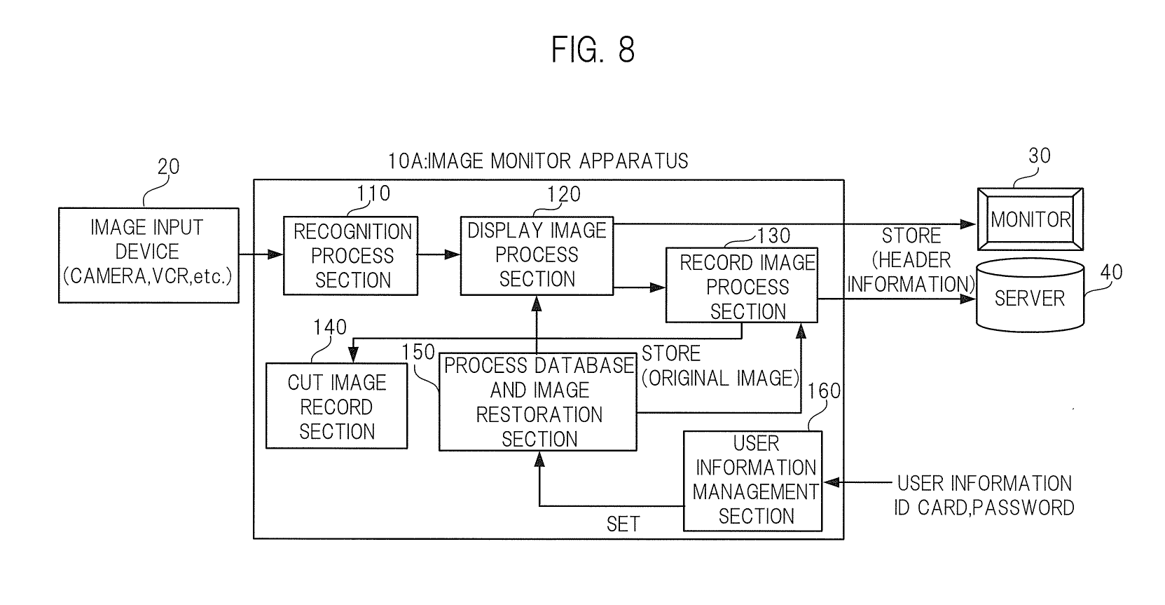

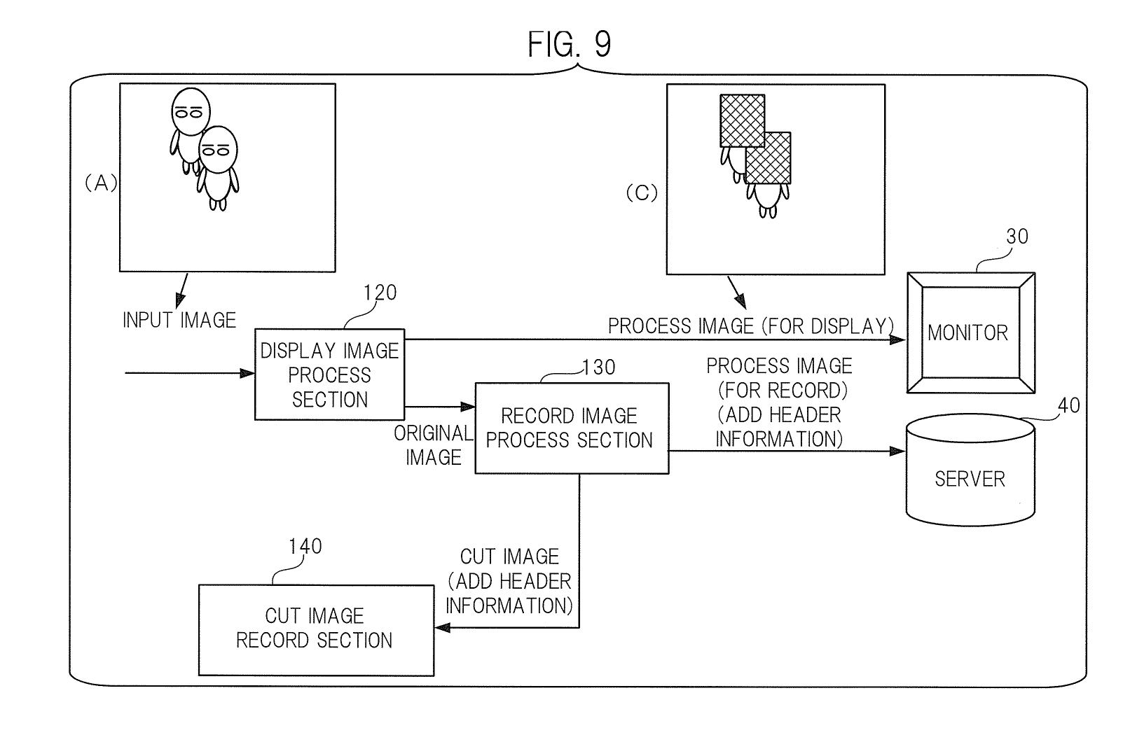

FIG. 8 is a diagram illustrating a flow of data at the time of recording an image of the image monitor apparatus 10A illustrated in FIG. 1. FIG. 9 is a diagram explaining a process for record by the record image process section 130. Incidentally, here, although image display is performed at the same time, image record will be mainly described, since image display is already explained.

Here also, firstly, user information through insertion of an ID card, input of a password or the like is informed to the user information management section 160. The user information management section 160 recognizes that a user has a proper authority based on the user information of the user. The user information management section 160 informs the process database and image restoration section 150 of information about an authority to use according to a current user and information about a pattern used for a process. The process database and image restoration section 150 informs the display image process section 120 of process information representing a pattern for display, and informs the record image process section 130 of process information representing a pattern for record.

As described above, in the display image process section 120 a pattern is pasted in the original image such that only a face is hidden to generate a process image (for display)(C), and this process image (for display) is sent to the monitor 30 to be displayed.

In addition, the original image and the position information about the process area for record (here, an area covers a person wholly) recognized by the recognition process section 110 (see FIG. 8) are inputted via the display image process section 120 to the record image process section 130. In the record image process section 130, a process image (for record) where a process area covering a person wholly in the original image is generated and outputted. This outputted process image (for record) is recorded in an external server 40. In this case, it is preferable to encrypt the process image (for record) so as to be outputted. In addition, in the record image process section 130, only an image of the process area covering the person wholly in the original image is cut out, and the cut out image (cut image) is recorded in the cut image record section 140. It is preferable that this cut image is also encrypted.

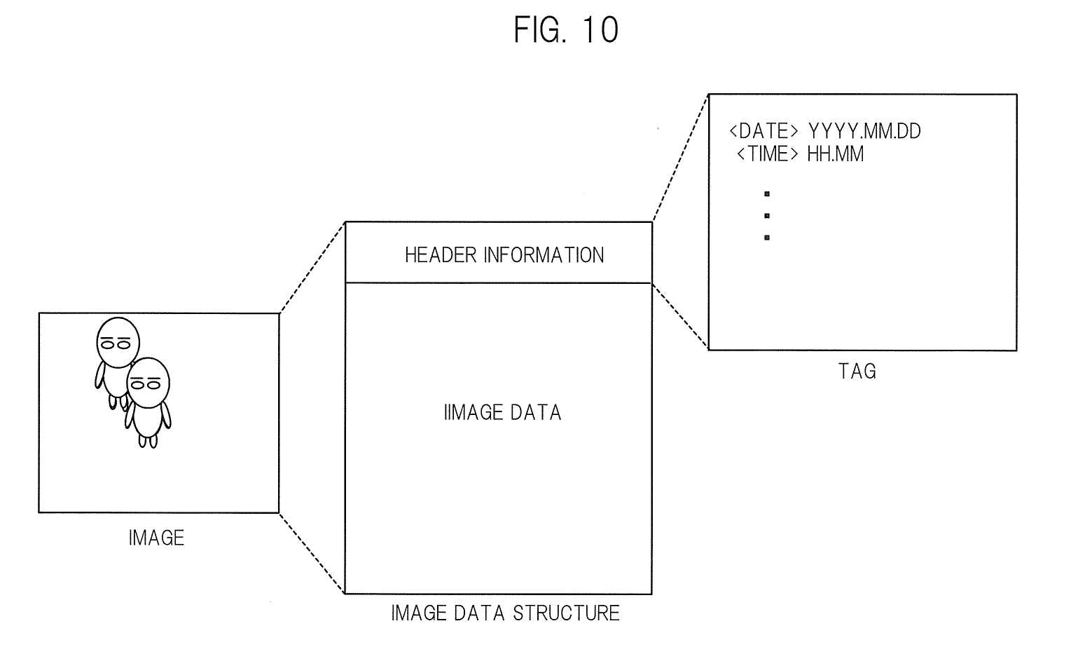

FIG. 10 is a diagram illustrating a data structure of an image.

The image is composed of header information and image data. In the header information, tag information to specify each frame of the image such as date and time of shooting is recorded.

Tag information in which cut position information indicating which position the cut image is cut from in the original image is further added to the tag information illustrated in FIG. 10 is attached to both the process image (for record) and the cut image outputted from the record image process section 130. At the time of image reproduction described later, the original image is restored based on this tag information. Further, to this tag information is added also position information of the process area for display recognized by the recognition process section 110. The position information of the process area for display is used to generate a process image (for display) in the display image process section 120 at the time of image reproduction.

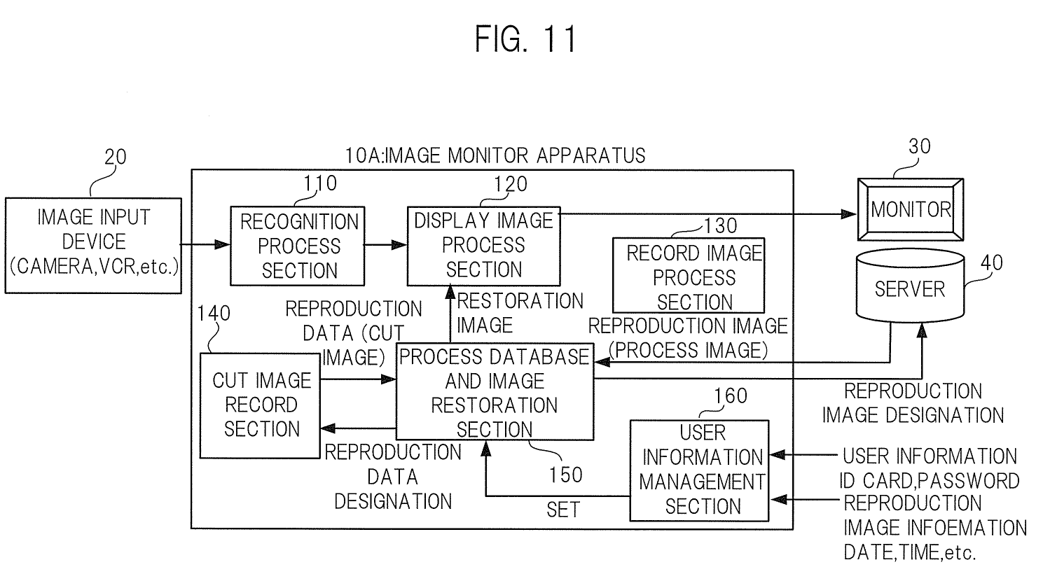

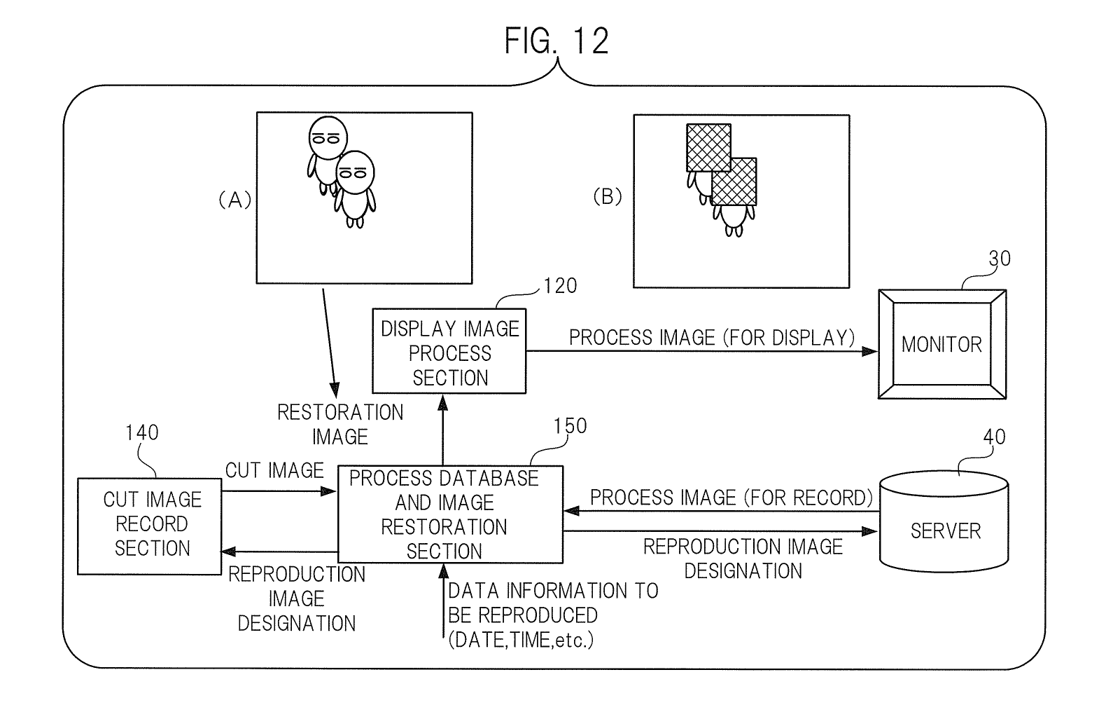

FIG. 11 is a diagram illustrating a flow of data at the time of image reproduction of the image monitor apparatus 10A illustrated in FIG. 1. FIG. 12 is a diagram explaining an original image restoration process by the process database and image restoration section at the time of reproduction of an image.

In here also, firstly, through insertion of an ID card or input of a password and the like, user information is informed to the user information management section 160. In addition, reproduction image information required at the time of image reproduction such as date and time when an image is recorded is also inputted, here.

Then, from the user information management section 160 to the process database and image restoration section 150, an authority to use and the like of a current user is informed, and further reproduction image information is also informed. The process database and image restoration section 150 designates an image to be reproduced based on the informed reproduction information, and sends to the server 40 and the process database and image restoration section 150 an instruction to send the image. Upon receipt of the instruction, the server 40 sends a process image (for record) which is designated by the instruction, and is recorded in the server 40 to the image monitor apparatus illustrated 10A. In addition, the cut image designated by the instruction is read out from the cut image record section 140.

In the process database and image restoration section 150, the process image (for record) sent from the server 40 and the cut image read out from the cut image record section 140 (after decryption when encrypted) are coupled based on the tag information (see FIG. 10) to restore an original image taken in the past, and the restored image is input to the display image process section 120.

In the display image process section 120, a process image (for display) is generated based on the reproduced image and the position information of the process image for display in the tag information and the generated process image is sent to the monitor 30. The monitor 30 displays a visible image based on the process image (for display). When an authority to use of the current user is, for example, like the person “A” illustrated in FIG. 2, “PERMITTED TO VIEW ALL,” in the display image process section 120, a process of hiding is not performed, and the original image restored by the process database and image restoration section 150 is displayed as it is on the monitor 30 without a process of hiding.

According to the image monitor apparatus 10A of the first embodiment explained above, a process image (for record) is recorded in the external server 40 and only an image in a partial area cut out in view of protection of privacy and the like is recorded in the cut image record section 140 and thus the images are separately recorded so that privacy and the like are securely protected.

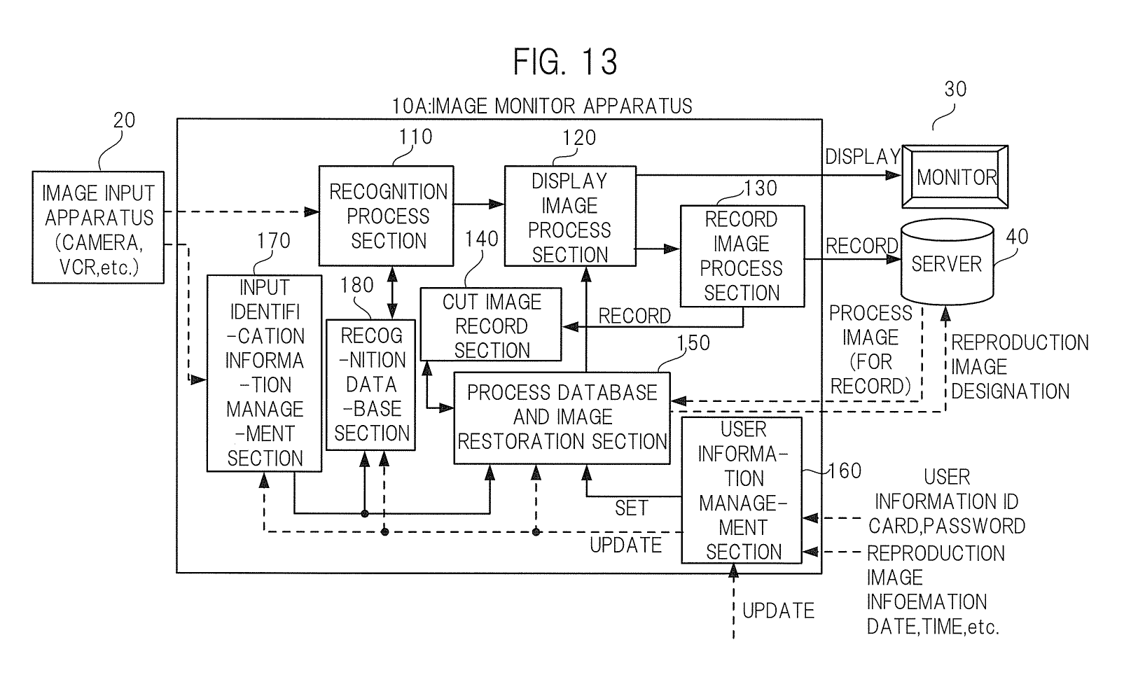

FIG. 13 is a diagram illustrating an image monitor system including an image monitor apparatus 10B of a second embodiment according to the invention.

The image monitor apparatus 10B and the image monitor system illustrated in FIG. 13, the same elements as those in the image monitor apparatus 10A and the image monitor system illustrated in FIG. 1 are denoted with the same references as those attached in FIG. 1, and only differences from FIG. 1 will be explained.

Comparing to the image monitor apparatus 10A illustrated in FIG. 1, to the image monitor apparatus 10B illustrated in FIG. 13 are added an input identification information management section 170 and a recognition process database section 180. In addition, here, plural cameras and the like as the image input device 20 may be connected to the image monitor apparatus 10B, and the recognition process section 100 and other sections process plural images inputted from the plural cameras and the like.

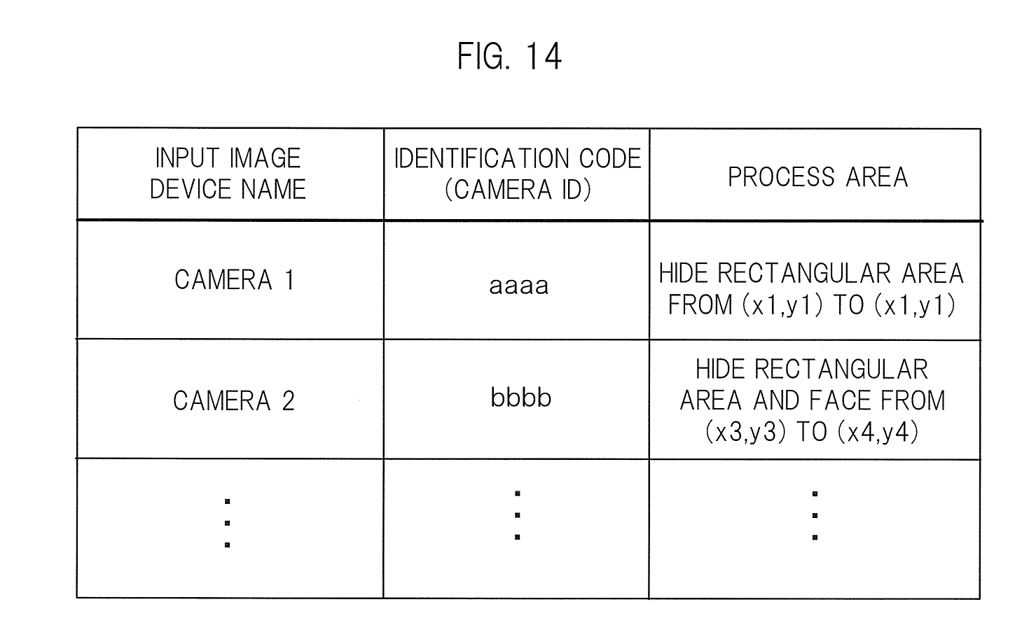

FIG. 14 is a diagram illustrating input identification information managed in the input identification information management section 170.

Here, “INPUT IMAGE DEVICE NAME”, “IDENTIFICATION CODE”, and “PROCESS AREA” are associated.

Here, plural cameras are arranged in monitoring places different from each other, and images from those plural cameras are inputted to the image monitor apparatus 10B. The input information illustrated here indicates a condition for monitoring of each of the cameras, and it is illustrated that, for example, in the “CAMERA 1”, a rectangular area from (x1, y1) to (x2, y2) in an image obtained through shooting by the CAMERA 1 is hidden independently of a user. The rectangular area, for example, is an area that is originally not necessary to be monitored, for example, such as an area where a neighbor's house is taken, and the area is designated to be always hidden. It is illustrated that the “CAMERA 2” is arranged at a place where monitoring up to a face is a significant invasion of privacy and, a rectangular area from (x3, y3) to (x4, y4) is always hidden and in other areas, an area of a face is also always hidden.

An identification code of the image input device (camera) is included in the header information (see FIG. 10) of the image inputted from the image input device (camera) 20. The input identification information management section 170 reads out information about a process area based on the identification code and sends the information to the process database and image restoration section 150. The process database and image restoration section 150 sends information about the area to be hidden to the display image process section 120 and the record image process section 130 based on the information about the process area. The display image process section 120 and the record image process section 130 perform a process based on the information sent from the process database and image restoration section 150 as well as the information about the process area recognized by the recognition process section 110.

In addition, in the recognition process database section 180 of the image monitor apparatus 10B illustrated in FIG. 13 is stored a recognition process algorism to be used when a process area is recognized by the recognition process section 110. In the recognition process database section 180 are rewritably (or plural algorisms are simultaneously) stored an algorism (for example, see the non-patent document 1 described above) to detect for example a whole person to set an area surrounding the whole person, an algorism (for example, see the non-patent document 2 described above) to recognize a face of a person to set an area surrounding the recognized face, or an algorism (for example, see the non-patent document 3 described above) to detect a car license plate to set an area surrounding the car license plate. In the recognition process section 110, a recognition process for a process area is performed based on the recognition process algorism sent from the recognition process database section 180.

As this configuration is adopted, it is possible to store a recognition algorism according to a use of the image monitor apparatus 10B in the recognition process database section 180 and to cause the recognition process section 110 to perform various recognition processes according to the use.

Or, the recognition algorism sent form the recognition process database section 180 to the recognition process section 110 may be changed according to a camera recognized by the input identification information management section 170. In this case, a recognition target in a process area may be changed for each camera in such a manner that one camera recognizes a person, and another camera recognizes a car license plate.

The input identification information stored in the input identification information management section 170 and the recognition process database stored in the recognition process database section 180 are updated by input of an electronic file or insertion of a key in the user information management section 160 similarly to the process database stored in the process database and image restoration section 150. That is, through insertion of an ID card, input of a password or the like, the user information management section 160 is caused to recognize an administrator having a proper authority. Through input of an electronic file, insertion of a key and the like, the of an electronic file, key-in and the like, the input recognition information of the input identification information management section 170 and the recognition database of the recognition process database section 180 are updated via the user information management section 160. Update information such as the administrator who has performed the update and date and time of the update is stored as a history in the user information management section 160.

As described, according to the image monitor apparatus 10B in FIG. 13, it is possible to further deal with plural cameras and the like and various recognition targets in addition to the same feature as that where the security of a record image is improved in the image monitor apparatus 10A illustrated in FIG. 1, and thus it is obtained to improve general versatility.

Incidentally, in the embodiments described above, the image monitor apparatuses configured by hardware are explained. However, using an information processing apparatus such as a personal computer for general purpose provided with a function to input an image and a function to perform communication via a communication line such as the Internet, and by causing the information processing apparatus to execute a program, the information processing apparatus may be configured to operate as one of the image monitor apparatuses described above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An image monitor apparatus, comprising;
a recognition process section that recognizes a process area in an original image which is inputted;
a display image process section that generates and outputs an image for display by subjecting a process for display according to a user to the process area recognized by the recognition process section in the original image;
a cut image record section that records an image of a partial area of the original image, the image cut from the original image; and
a record image process section that cuts the process area recognized by the recognition process section from the original image and causes the cut image record section to record an image in the process area of the original image, and generates and outputs an image for record by subjecting a process for record to the process area recognized by the recognition process section.

2. The image monitor apparatus according to claim 1, further comprising:
an image restore section that inputs both the image for record in the past which has generated and has outputted by the record image process section and the image of the process area in the past which has been cut by the record image process section and has been recorded in the cut image record section to restore the original image and passes the original image to the display image process section.

3. The image monitor apparatus according to claim 1, further comprising:
an input identification information management section that identifies a plurality of image input devices which generate the original image and input the original image to the image monitor apparatus, wherein
the display image process section generates and outputs the image for display by subjecting a process according to the user and also according to an image input device which has generated and inputted the original image to the process area recognized by the recognition process section of the original image.

4. The image monitor apparatus according to claim 2, further comprising:

5. The image monitor apparatus according to claim 1, further comprising:
a recognition process database section that stores a recognition process an algorism to recognize the process area from the original image which is inputted and informs the recognition process section of the algorism, wherein
the recognition process section recognizes the process area in the original image which is inputted by performing a recognition process according to the algorism informed from the recognition process database section.

6. The image monitor apparatus according to claim 2, further comprising:
a recognition process database section that stores a recognition process an algorism to recognize the process area from the original image which is inputted and informs the recognition process section of the algorism, wherein
the recognition process section recognizes the process area in the original image which is inputted by performing a recognition process according to the algorism informed from the recognition process database section.

7. The image monitor apparatus according to claim 3, further comprising:
a recognition process database section that stores a recognition process an algorism to recognize the process area from the original image which is inputted and informs the recognition process section of the algorism, wherein
the recognition process section recognizes the process area in the original image which is inputted by performing a recognition process according to the algorism informed from the recognition process database section.

8. A computer-readable medium storing an image monitor program that is executed in an information processing apparatus to cause the information processing apparatus to operate as:
a recognition process section that recognizes a process area in an original image which is inputted;
a display image process section that generates and outputs an image for display by subjecting a process for display according to a user to the process area recognized by the recognition process section in the original image;
a cut image record section that records an image of a partial area of the original image, the image cut from the original image; and
a record image process section that cuts the process area recognized by the recognition process section from the original image and causes the cut image record section to record an image in the process area of the original image, and generates and outputs an image for record by subjecting a process for record to the process area recognized by the recognition process section.

9. The computer-readable medium, according to claim 8, storing the image monitor program that is executed in an information processing apparatus to cause the information processing apparatus to further operate as:
an image restore section that inputs both the image for record in the past which has generated and has outputted by the record image process section and the image of the process area in the past which has been cut by the record image process section and has been recorded in the cut image record section to restore the original image and passes the original image to the display image process section.

10. The computer-readable medium, according to claim 9, storing the image monitor program that is executed in an information processing apparatus to cause the information processing apparatus to further operate as:
an input identification information management section that identifies a plurality of image input devices which generate the original image and input the original image to the image monitor apparatus, wherein
the display image process section generates and outputs the image for display by subjecting a process according to the user and also according to an image input device which has generated and inputted the original image to the process area recognized by the recognition process section of the original image.

11. The computer-readable medium, according to claim 10, storing the image monitor program that is executed in an information processing apparatus to cause the information processing apparatus to further operate as:
an input identification information management section that identifies a plurality of image input devices which generate the original image and input the original image to the image monitor apparatus, wherein
the display image process section generates and outputs the image for display by subjecting a process according to the user and also according to an image input device which has generated and inputted the original image to the process area recognized by the recognition process section of the original image.

12. The computer-readable medium, according to claim 8, storing the image monitor program that is executed in an information processing apparatus to cause the information processing apparatus to further operate as:
a recognition process database section that stores a recognition process an algorism to recognize the process area from the original image which is inputted and informs the recognition process section of the algorism, wherein
the recognition process section recognizes the process area in the original image which is inputted by performing a recognition process according to the algorism informed from the recognition process database section.

13. The computer-readable medium, according to claim 9, storing the image monitor program that is executed in an information processing apparatus to cause the information processing apparatus to further operate as:
a recognition process database section that stores a recognition process an algorism to recognize the process area from the original image which is inputted and informs the recognition process section of the algorism, wherein
the recognition process section recognizes the process area in the original image which is inputted by performing a recognition process according to the algorism informed from the recognition process database section.

14. The computer-readable medium, according to claim 10, storing the image monitor program that is executed in an information processing apparatus to cause the information processing apparatus to further operate as:
a recognition process database section that stores a recognition process an algorism to recognize the process area from the original image which is inputted and informs the recognition process section of the algorism, wherein
the recognition process section recognizes the process area in the original image which is inputted by performing a recognition process according to the algorism informed from the recognition process database section.

15. The computer-readable medium, according to claim 11, storing the image monitor program that is executed in an information processing apparatus to cause the information processing apparatus to further operate as:
a recognition process database section that stores a recognition process an algorism to recognize the process area from the original image which is inputted and informs the recognition process section of the algorism, wherein
the recognition process section recognizes the process area in the original image which is inputted by performing a recognition process according to the algorism informed from the recognition process database section.
